(19) United States
(12) Patent Application Publication
(10) Pub. No.: US 2008/0299483 A1
(43) Pub. Date: Dec. 4, 2008

(54) Method for recycling an image-forming member

(75) Inventors: Yoshihisa Mizumoto, Hyogo (JP); Noriaki Hitomi, Hyogo (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 12/149,565

(22) Filed: May 5, 2008

(30) Foreign Application Priority Data
May 31, 2007 (JP) 2007-144888

(51) Int. Cl. G03G 13/00

(52) U.S. Cl. 430/130

(57) ABSTRACT

The present invention provides a method for recycling a spent image-forming member mounted inside an image-forming apparatus to reuse the image-forming member. In the method, the image-forming member is made of an elastomer before the image-forming member is recycled; and when a recycling work is performed, a surface of the image-forming member is not abraded, but irradiated with ultraviolet rays or ozone at least once to decompose or/and deteriorate a deposit which has attached to the surface thereof in a use thereof so that the deposit is removed from the surface thereof.

This nonprovisional application claims priority under 35 U.S.C. § 119(a) on Patent Application No(s). 2007-144888 filed in Japan on May 31, 2007, the entire contents of which are hereby incorporated by reference.

### FIELD OF THE INVENTION

The present invention relates to a method for recycling an image-forming member and more particularly to a method for recycling an image-forming member spent inside an image-forming apparatus in the form of a cartridge and re-utilizing it by mounting it again inside the image-forming apparatus.

### DESCRIPTION OF THE RELATED ART

The image-forming apparatus represented by a laser beam printer and an inkjet printer has spread widely not only as a business use but also as a home use. A large number of image-forming apparatuses have hit the market. In the image-forming apparatus, consumed component parts are replaced collectively as a built-in replacement part, namely, as a cartridge.

A large number of members such as a rubber roller formed from an elastomer composition (hereinafter referred to as “elastomer member”) is incorporated in the cartridge. For example, a developing roller, a toner supply roller, a developing blade, and the like are incorporated in a toner cartridge. A charging roller, a cleaning roller, a transfer roller, a cleaning blade, and the like are incorporated in a photosensitive drum cartridge. A fixing roller is incorporated in a fixing cartridge. When print is made on a predetermined number of sheets of paper, the elastomer members are collected in the form of a cartridge and discarded.

But from the standpoint of the protection of environment and effective utilization of resources, there is a demand for the recycling of the spent elastomer members. Because mostly dirt (deposit) attaches to the surfaces of the elastomer members with age, the elastomer members do not show an initial performance. Thus it becomes difficult to use the spent elastomer member and is discarded. For example, when dirt has attached to the surface of a developing roller, it becomes difficult to sufficiently electrically charge toner to form a defective image.

Although the spent elastomer member maintains the initial properties in the inside thereof except the surface thereof, the spent elastomer member is discarded owing to a deposit which has attached to the surface thereof. To recycle the elastomer member, it is necessary to effectively remove the deposit.

A method for recycling the member for the image-forming apparatus by removing the deposit which has attached to the surface thereof is disclosed in Japanese Patent Application Laid-Open No. 2006-163115 (patent document 1). In this method, the surface layer of the member, for an image-forming apparatus, made of a conductive resin composition is removed in the predetermined range (50 to 2000 μm) by grinding the surface of the member for the image-forming apparatus by the addition of an electrolyte.

Patent document 1: Japanese Patent Application Laid-Open No. 2006-163115

The method of the patent document 1 has been developed to remove dirt which has deposited on the surface of the member for the image-forming apparatus by grinding the surface thereof to recycle it. Thus the dirt can be securely removed.

But it is very difficult for the method of the patent document 1 of grinding (abrading) the surface of the member for the image-forming apparatus at a high dimensional accuracy and thus obtain a recycled elastomer member having performance similar to that displayed by an original elastomer member. This is because when a grinding depth is small, it is impossible to chuck the spent elastomer member which has been stained or worn as accurately as the original elastomer member at a grinding time and set the recycled elastomer member at a predetermined position. To uniformly abrade the surface of the member for the image-forming apparatus in a slight dimension, a high technique and a large amount of labor are required. For example, in abrading a roller-shaped member, namely, a roller, when the axial position of a grinding member which abrades the roller at the time of the production thereof shifts in a small amount from the axial position of a grinding member which abrades the spent roller to recycle it, the axis of the recycled roller becomes eccentric from that of the original roller when the spent roller is abraded and some portions are left unabraded. Therefore it is very difficult to abrade the spent roller without making the axis thereof eccentric within a region not more than 500 μm and particularly not more than 100 μm.

When the spent roller is abraded in a large grinding depth, the state of contact (contact pressure and contact nip) between the recycled roller and a component part of the image-forming apparatus such as a photosensitive member is different from the state of contact between the original roller and the photosensitive member. Thus the recycled roller is incapable of providing performance similar to that of the original roller. For example, an ordinary roller has a radius of 5 to 10 mm. Thus when the roller is abraded in the depth of not less than 500 μm, the state of contact between the roller and the other component part of the image-forming apparatus may change.

As described above, it is very difficult to obtain the elastomer member having performance similar to that of the original elastomer member and having a small difference from the original elastomer member in its dimension.

### SUMMARY OF THE INVENTION

The present invention has been made to solve the above-described problems. Therefore it is an object of the present invention to provide a method for recycling a spent image-forming member without abrading the spent image-forming member so that a recycled image-forming member has a state close to the performance of the original image-forming member with the recycled image-forming member maintaining an initial dimensional accuracy.

To achieve the above-described object, the present invention provides a method for recycling a spent image-forming member mounted inside an image-forming apparatus to reuse the image-forming member. In the method, the image-forming member is made of an elastomer before the image-forming member is recycled; and when a recycling work is performed, a surface of the image-forming member is not abraded, but irradiated with ultraviolet rays or ozone at least once to decompose or/and deteriorate a deposit which has attached to the surface thereof in a use thereof so that the deposit is removed from the surface thereof.

The deposits including at least one of toner, wax which is a component of the toner, paper powder, a liquid additive, and a low-molecular-weight polymer attach to the surface of the image-forming member to be recycled; and the image-forming member is exchangeably mounted on an image-forming apparatus as a cartridge and consists of a developing roller, a toner supply roller, and a developing blade constructing a toner cartridge, a charging roller, a cleaning roller, a transfer roller, and a cleaning blade constructing a photosensitive drum cartridge or/and a fixing roller constructing a fixing cartridge.

As described above, the recycling method of the present invention is different from the method, of the patent document 1, for removing dirt by abrading the surface of the image-forming member. In the recycling method of the present invention, the surface of the image-forming member is irradiated at least once with ultraviolet rays or ozone to easily remove dirt which has attached to and accumulated on the surface of the image-forming member by decomposing and deteriorating the dirt. Unlike the method of the patent document 1 for removing dirt by abrading the surface of the image-forming member, the recycling method of the present invention is capable of easily restoring the performance of the image-forming member without damaging an initial dimensional accuracy provided when the image-forming member is produced.

The image-forming member contacts toner, an additive externally added to the toner, and components of paper powder (calcium carbonate, silica, fiber of paper) which reach inside a cartridge. A mechanical stress is applied to the toner in contact with the surface of the image-forming member owing to an endurance use. As a result, the toner cracks or deforms. Consequently a liquid or paste in which wax contained inside toner, a liquid additive, and a low-molecular-weight polymer, and the like are mixed with each other and attach to the surface of the elastomer member. As the use of the image-forming member proceeds, there occurs a phenomenon called filming that the liquid or the paste stick to the surface of the elastomer member to form a film thereon.

Solid matters such as paper powder, the additive externally added to the toner, and the like are easy to attach to the surface of the elastomer member with the intermediary of the liquid or paste and gradually accumulate thereon owing to the endurance use.

Normally the dirt does not uniformly attach to the surface of the elastomer member. For example, in the case of a roller, the dirt is liable to thickly attach to the vicinity of the axial end of the roller to which a high pressure is applied and nonuniformly attach to the roller at a portion thereof in the circumferential direction thereof. Thus when the elastomer member is used without recycling it, print is liable to be made at a nonuniform concentration.

The components of the dirt (deposit) which attaches to the elastomer member owing to the endurance use are as follows: The following component (1) and powder (3) are present on the surface of the elastomer member with the intermediary of the component (2):

(1): Resin forming toner and components present on the surface of the toner (additive externally added to toner and the like contained in toner to enhance flowability)

(2): Components (wax, liquid additive, low-molecular-weight polymer, colorant, and the like) contained in the toner

(3): Powder (calcium carbonate and silica used as fillers of paper, fibers of paper, and the like) of paper on which print is made.

In the recycling method of the present invention, by irradiating the elastomer member with the ultraviolet rays or/and the ozone, the component (2) serving as a medium (joining material) to which the components (1) and (3) attach and on which the components (1) and (3) accumulate is oxidatively decomposed and deteriorated. It is preferable to vaporize and/or solidify the component (2) so that the entire dirt can be easily separated from the surface of the elastomer member.

In addition rubber, present on the surface of the elastomer member, which has been worn, activated, and become low in its molecular weight also serves as a medium to which the components (1) and (3) attach to and on which they accumulate.

In the present invention, the medium is irradiated with the ultraviolet rays or/and the ozone to efficiently oxidize the medium. Thereby the medium is made non-tacky or frail so that the dirt can be removed easily and efficiently.

Consequently it is possible to recycle the image-forming member without changing the original state and maintain an initial dimensional accuracy because the surface thereof is not abraded. The treatment of the surface of the image-forming member by means of the ultraviolet rays can be preferably accomplished because the treating period of time is short and the treating cost is inexpensive.

In the method of the present invention for recycling the spent image-forming member, as described above, the surface of the image-forming member is irradiated at least once with the ultraviolet rays or the ozone. But it is possible to irradiate the surface of the image-forming member at a plurality of times with the ultraviolet rays or the ozone and also possible to use the ultraviolet rays and the ozone in combination.

It is possible to remove dirt (large deposit such as toner, paper powder, and the like having a size not less than 1 μm) which can be easily dropped owing to vibration caused by means of air blow, suction, and water-washing, before the surface of the image-forming member is irradiated with the ultraviolet rays or/and the ozone. In that case, it is possible to efficiently apply the ozone or/and the ultraviolet rays to the dirt which has strongly attached to the surface of the image-forming member.

Alternatively after the surface of the image-forming member is irradiated with the ultraviolet rays or/and the ozone to allow the deposit to be separated easily from the surface thereof owing to the oxidative decomposition and oxidative deterioration. Thereafter the air blow, the suction, and the water-washing are performed. Thereby the deposit can be securely separated and removed from the surface of the image-forming member.

It is also preferable to perform any one of the air blow, the suction, and the water-washing before and after the surface of the image-forming member is irradiated with the ultraviolet rays or/and the ozone.

The deposit which has attached to the surface of the image-forming member may separate therefrom of themselves by irradiating the surface thereof with the ultraviolet rays or/and the ozone. In this case, it is unnecessary to perform the air blow, the suction, and the water-washing.

As the detailed method of the present invention for recycling the spent image-forming member, the following methods (A) through (E) are listed:

(A): After a large deposit having a size not less than 1 μm is removed by blowing the surface of the spent image-forming member and washing the surface thereof with water, the surface thereof is irradiated with the ozone or/and the ultraviolet rays.

(B): The surface of the spent image-forming member is irradiated with the ozone or/and the ultraviolet rays to deteriorate the components of the above-described component (2) so that the component (2) can be easily separated from the surface thereof. Thereafter the air blow or/and the water-washing are carried out to remove the deposit.

(C): After the work at the step (A) finishes, the air blow or the water-washing is carried out again.

(D): After the work at the step (A) finishes, the air blow or the water-washing is carried out again. Thereafter the surface of the spent image-forming member is irradiated with the ozone or/and the ultraviolet rays again.

(E): After the work at the step (B) finishes, the surface of the spent image-forming member is irradiated with the ozone or/and the ultraviolet rays again.

In recycling the spent image-forming member by irradiating the surface thereof with the ultraviolet rays, the intensity of the ultraviolet rays and the irradiation condition (period of time, temperature inside bath, distance) are selected in dependence on an extent of dirt to obtain the performance of the image-forming member displayed by the image-forming member when it was produced (new article). In one-time irradiation of the ultraviolet rays, the wavelength thereof is set to favorably 100 to 400 nm and more favorably 100 to 200 nm for 30 seconds to 30 minutes and favorably one to 10 minutes, although the above-described wavelength and the irradiation period of time are different according to the distance between the surface of the image-forming member and an ultraviolet rays lamp and the kind of the elastomer. It is preferable to irradiate the surface of the image-forming member by moving the elastomer member or the ultraviolet rays lamp so that the surface of the image-forming member can be uniformly irradiated with the ultraviolet rays. When the elastomer member is roller-shaped, it is preferable to irradiate the surface of the elastomer member by rotating the roller.

Similarly in recycling the spent image-forming member by irradiating the surface thereof with the ozone, the concentration of the ozone and the irradiation condition (period of time, humidity, temperature inside bath) are selected according to a producing equipment, the layout of a factory (number of persons, cycle), and the extent of dirt.

For example, in one-time irradiation of the ozone at 23° C. and a relative humidity of 55%, the surface of the image-forming member is exposed to the ozone in 0.5 minutes to 50 hours and more favorably one minute to 24 hours and most favorably one minute to 12 hours in an atmosphere of 0.01 to 100 ppm, more favorably 0.1 to 10 ppm, and most favorably 0.2 to 5 ppm.

When the concentration of the ozone is less than 0.01 ppm, the oxidative effect thereof is so weak that the ozone irradiation is used inefficiently. When the concentration of the ozone is more than 100 ppm, the ozone irradiation is not preferable in the management of an apparatus, and the apparatus cannot be used safely.

The method of the present invention for recycling the spent image-forming member is applicable to those composed of the elastomer disposed on its outermost surface exposed to the outside. The image-forming member may have a plurality of layers other than the layer consisting of the elastomer. But the image-forming member having a single layer consisting of the elastomer has little variation in its properties and can be produced at a low cost and is thus used by many and thereby can be preferably used in the recycling method of the present invention.

The oxide film is formed on the surface of the above-described elastomer when the image-forming member is produced. When the oxide film remains in recycling the spent image-forming member, the elastomer layer is treated as the layer containing the oxide film on the surface thereof.

It is necessary that the elastomer disposed on the outermost surface of the image-forming member exposed to the outside contains an elastic polymer (elastomer) such as resin, rubber, dynamically crosslinked rubber (dynamically crosslinked elastomer) as an elastomer component.

For example, as the elastomer component, the following substances are listed:

Listed as rubber components are epihalohydrin copolymers such as chloroprene rubber, acrylonitrile-butadiene rubber, carbonyl group-introduced acrylonitrile-butadiene rubber, hydrogenated acrylonitrile-butadiene rubber, natural rubber, butadiene rubber, styrene-butadiene rubber, isoprene rubber, butyl rubber, acrylic rubber, epihalohydrin copolymer such as epihalohydrin rubber (especially, epichlorohydrin rubber); and ethylene propylene rubber, ethylene-propylene-diene copolymer rubber, polyurethane rubber, chlorinated butyl rubber, acrylonitrile rubber, fluororubber, silicone rubber, and a polyether polymer containing ethylene oxide.

As the dynamically crosslinked rubber, known thermoplastic elastomers can be used.

For example, styrene elastomer, chlorinated polyethylene, vinyl chloride-based elastomer, olefin elastomer, urethane elastomer, ester elastomer, and amide elastomer are listed.

The above-described elastomer components can be used singly or as a mixture of not less than two kinds thereof.

It is preferable that the elastomer component disposed on the outer surface of the image-forming member which is used in the recycling method of the present invention is little deteriorated by the irradiation of the ultraviolet rays or/and the ozone.

As elastomer components to be little deteriorated by the irradiation of the ultraviolet rays or/and the ozone, chloroprene rubber, chlorinated polyethylene, vinyl chloride-based elastomer, epichlorohydrin copolymer, and chlorinated butyl rubber are listed.

When the elastomer contains chlorine atoms, the inside of the elastomer member little deteriorates, even though the surface of the image-forming member is excessively irradiated with the ozone or/and the ultraviolet rays. Therefore it is easy to manage steps in the recycling operation and thus the elastomer containing the chlorine atoms can be preferably used.

As the elastomer containing the chlorine atoms, it is favorable that the elastomer contains polychloroprene and more favorable that it contains chloroprene rubber which is a rubber component.

When the image-forming member is a developing roller, it is possible to impart a very high electrical charge to toner by using the chloroprene rubber for the image-forming member.

The chloroprene rubber is a polymer of chloroprene and produced by emulsion polymerization. In dependence on the kind of a molecular weight modifier, the chloroprene rubber is classified into a sulfur-modified type and a sulfur-unmodified type.

In the chloroprene rubber of the sulfur-modified type, a polymer resulting from polymerization of sulfur and the chloroprene is plasticized with thiuram disulfide or the like to adjust the resulting chloroprene rubber to a predetermined Mooney viscosity.

The chloroprene rubber of the sulfur-unmodified type includes a mercaptan-modified type and a xanthogen-modified type. Alkyl mercaptans such as n-dodecyl mercaptan, tert-dodecyl mercaptan, and octyl mercaptan are used as molecular weight modifiers for the mercaptan-modified type. Alkyl xanthogen compounds are used as molecular weight modifiers for the xanthogen-modified type.

In dependence on a crystallization speed of generated chloroprene rubber, the chloroprene rubber is classified into an intermediate crystallization speed type, a slow crystallization speed type, and a fast crystallization speed type.

Both the chloroprene rubber of the sulfur-modified type and the sulfur-unmodified type can be used in the present invention. But it is preferable to use the chloroprene rubber of the sulfur-unmodified type having the slow crystallization speed.

As the chloroprene rubber for the image-forming member of the present invention, it is possible to use rubber or elastomers having structures similar to the chloroprene rubber. It is also possible to use a copolymer obtained by polymerizing a mixture of the chloroprene and one or more kinds of monomers copolymerizable with the chloroprene. As the monomers copolymerizable with the chloroprene, 2,3-dichloro-1,3-butadiene, 1-chloro-1,3-butadiene, sulfur, styrene, acrylonitrile, methacrylonitrile, isoprene, butadiene, acrylic acid, methacrylic acid, and esters thereof are listed.

When the image-forming member is the developing roller containing the chloroprene rubber in the elastomer thereof disposed on the outer surface thereof, the developing roller is capable of holding the charged amount of toner disposed on the surface thereof at a high level before the developing roller contacts a photosensitive member, thus allowing a high-quality image to be formed.

The content of the chloroprene rubber in the elastomer disposed on the outer surface of the image-forming member is appropriately selected in the range from 1 to 100 parts by mass in 100 parts by mass of the entire elastomer component. In consideration of the effect of imparting the electrostatic property to the toner, it is favorable that not less than 5 parts by mass of the chloroprene rubber is contained in 100 parts by mass of the entire elastomer component. In consideration of the uniformity of the rubber, it is more favorable that not less than 10 parts by mass of the chloroprene rubber is contained in 100 parts by mass of the entire elastomer component.

When the elastomer disposed on the outer surface of the image-forming member consists of a mixed rubber of the chloroprene rubber and other rubber, the following rubbers or mixed rubbers thereof are listed: epihalohydrin rubber (epichlorohydrin rubber is especially preferable), urethane rubber, acrylonitrile rubber, butadiene rubber, acrylonitrile butadiene rubber (NBR), styrene butadiene rubber, butyl rubber, fluororubber, isoprene rubber, silicone rubber, and a polyether polymer containing ethylene oxide. It is preferable to mix the chloroprene rubber with a polar rubber especially with NBR to suppress a rise of the hardness of the elastomer component and decrease the degree of dependence thereof on temperature. It is preferable that the mixing amount of rubber such as the NBR liable to be deteriorated by being irradiated with the ultraviolet rays is set to not more than 50 parts by mass in 100 parts by mass of the entire elastomer component.

In mixing the NBR with the chloroprene rubber as the elastomer component, it is preferable to add 5 to 50 parts by mass of the NBR in 100 parts by mass of the entire elastomer component. To prevent a decrease of the charged amount of toner, it is preferable to set the content of the NBR to not more than 50 parts by mass in 100 parts by mass of the entire elastomer component. To suppress a rise of the hardness of the elastomer component and substantially obtain the effect of decreasing the degree of dependence thereof on temperature, it is preferable to set the content of the NBR to the range from 5 to 20 parts by mass in 100 parts by mass of the entire elastomer component.

It is preferable that when the image-forming member is required to be conductive, the elastomer disposed on the outer surface thereof is ionic-conductive or electroconductive or both ionic-conductive and electroconductive.

In order for the elastomer member to obtain a more uniform electrical characteristic, it is preferable that the elastomer member is ionic-conductive and that log(R100)−log(R500)<0.5, supposing that the electric resistance value of the elastomer member is R500 when a voltage of 500V is applied thereto, and the electric resistance value thereof is R100 when a voltage of 100V is applied thereto. This is to clarify the uniformity of the electrical characteristic of the elastomer member by setting the difference between the reference electric resistance value thereof when the voltage of 500V close to a developing bias is applied thereto and the electric resistance value thereof when the voltage of 100V is applied thereto as an index. It is preferable that the elastomer of the conductive image-forming member has an ionic conductivity depending on a voltage to a low extent.

When the elastomer component is dependent on the electronic conductivity because carbon black or the like is added thereto, the value of the above-described equation is not less than one. The method of measuring the electric resistance value is as described in the example which will be described later.

To make the elastomer component ionic-conductive, a known method of mixing an ionic-conductive rubber therewith and a known method of adding an ionic-conductive agent thereto is used. As the ionic-conductive rubber, rubber materials each having a polar group in the composition thereof are listed.

As the ionic-conductive rubbers, it is possible to preferably use epihalohydrin rubber (epichlorohydrin is especially preferable) and elastomers containing ethylene oxide. More specifically, it is possible to use epichlorohydrin (EP) homopolymer, an epichlorohydrin-ethylene oxide (EO) copolymer, an epichlorohydrin-propylene oxide (PO) copolymer, an epichlorohydrin-allyl glycidyl ether (AGE) copolymer, an epichlorohydrin-ethylene oxide-allyl glycidyl ether copolymer, an epichlorohydrin-propylene oxide-allyl glycidyl ether copolymer, and an epichlorohydrin-ethylene oxide-propylene oxide-allyl glycidyl ether copolymer.

These ionic-conductive rubbers contain oxygen and chlorine. In these ionic-conductive rubbers having a high polarity, oxygen added thereto owing to the oxidation caused by the irradiation of the ultraviolet rays or/and the ozone is capable of being present therein very stably.

In mixing the ionic-conductive rubber with the chloroprene rubber, the content of the chloroprene rubber is set to favorably not more than 90 parts by mass, more favorably not more than 75 parts by mass, and most favorably not more than 60 parts by mass in 100 parts by mass of the entire elastomer component. From the standpoint of electrostatic property-imparting effect, the content of the chloroprene rubber is set to favorably not less than 5 parts by mass and more favorably not less than 10 parts by mass in 100 parts by mass of the entire elastomer component. When the charging characteristic of the toner is low, it is preferable to set the content of the chloroprene rubber to not less than 20 parts by mass.

It is preferable that in the elastomer containing the ethylene oxide, monomers composing the elastomer contain the ethylene oxide and that the elastomer contains rubber with which the epichlorohydrin is selectively mixed.

In this case, it is preferable that the total mol % of chloroprene monomers composing the chloroprene rubber and the epichlorohydrin is set higher than that of the ethylene oxide.

It is preferable that the mol % of the chloroprene monomers composing the chloroprene rubber is set higher than that of the epichlorohydrin.

It is preferable that the mol % of the chloroprene monomers composing the chloroprene rubber is set higher than that of the ethylene oxide.

It is very favorable that the elastomer component consists of a mixture of polyether polymers containing the epihalohydrin rubber having a high electrical conductivity and an ionic conductivity and the ethylene oxide because the electric resistance value of the elastomer component can be adjusted to a predetermined one.

To make the elastomer ionic-conductive, it is favorable to use weakly conductive carbon black as carbon black and add 10 to 70 parts by mass of the weakly conductive carbon black to 100 parts by mass of the entire elastomer component. It is more favorable to add 20 to 65 parts by mass of the weakly conductive carbon black to 100 parts by mass of the entire elastomer component and most favorable to add 25 to 60 parts by mass of furnace carbon black to 100 parts by mass of the entire elastomer component. Because such carbon black has a comparatively large particle diameter and is spherical, it makes a uniform nano-dispersion inside the elastomer. Therefore it is possible to make the elastomer uniformly and highly dielectric without coating it.

When the elastomer is not ionic-conductive, it is preferable to use known conductive carbon black such as Ketjen black, furnace black, acetylene black and the above-described weakly conductive carbon black in combination. It is preferable to mix 10 to 20 parts by mass of the conductive carbon black with 100 parts by mass of the entire elastomer component.

It is preferable that the image-forming member to be recycled by the recycling method of the present invention is composed of vulcanized rubber.

It is also preferable that in the production of the image-forming member, an oxide film is formed on the elastomer disposed on the outer surface thereof by irradiating the surface thereof with the ozone or/and the ultraviolet rays.

When the oxide film is formed on the outer surface of the produced image-forming member by irradiating the surface thereof with the ultraviolet rays or/and the ozone, the surface state of an initial article (new article) and that of a recycled product are similar to each other. Thus the recycled product is capable of obtaining performance similar to that of the new article. Hence the spent image-forming member can be recycled repeatedly.

The image-forming member on which the oxide film is formed when it is produced has an advantage that the dielectric loss tangent thereof can be controlled in a predetermined range because the oxide film serves as a dielectric layer and is capable of decreasing the dielectric loss tangent thereof. The oxide film also serves as a low-frictional layer. Thereby toner separates easily from the image-forming member. Hence it is possible to easily form an image and obtain a high-quality image.

It is preferable that the oxide film formed on the produced image-forming member (new article) has a large number of C═O groups or C—O groups. The oxide film is formed by irradiating the surface of the elastomer forming the outermost layer with the ultraviolet rays and/or the ozone and oxidizing the surface of the elastomer. It is preferable to form the oxide film by irradiating the surface of the elastomer with the ultraviolet rays because the use of the ultraviolet rays allows a treating period of time to be short and the oxide film-forming cost to be low.

The method for producing the oxide film on the image-forming member at the time of the production thereof can be carried out by using a known method. For example, the oxide film can be formed by using a method similar to an oxide film-forming method in the recycling method of the present invention.

As the image-forming member to be recycled by the recycling method of the present invention, as described above, the image-forming member constructing a toner cartridge, a photosensitive drum cartridge, and a fixing cartridge which is exchangeably mounted on an image-forming apparatus are listed.

The recycling method of the present invention is preferably used to recycle a spent developing roller constructing the toner cartridge.

It is preferable that the developing roller is used to attach an unmagnetic one-component toner having a positive electrostatic property to a photosensitive member. Especially when the chloroprene rubber is used for the elastomer of the developing roller, the developing roller can be preferably used for toner having the positive electrostatic property because owing to the rubber structure thereof, the developing roller has the performance of imparting a very high positive electrostatic property to the toner. But unlike other image-forming members, the developing roller is used under pressure with the toner always in contact with the developing roller. Thus for example, the toner attaches to the developing roller in a larger amount than on a transfer roller and the like which do not directly contact the toner. In addition, the developing roller is used inside the toner cartridge as consumable goods. Therefore the endurance period of time of the developing roller is shorter than those of component parts which are used inside a printer body. The developing roller is not discarded but is recycled by the recycling method of the present invention. Therefore the recycling method of the present invention is preferable because the recycling method is capable of lessening an increase of industrial wastes and preserving environment.

To improve the durability of the developing roller, decrease a change in the electric resistance thereof when it is in operation, decrease a stress to be applied to the toner, and prevent the photosensitive member from being damaged, it is preferable to produce the developing roller having the following properties.

Supposing that the electric resistance of the produced developing roller when a voltage of 50V is applied thereto is set to R50 before the oxide film is formed on the surface thereof, and the electric resistance thereof when a voltage of 50V is applied thereto is set to R50a after the oxide film is formed on the surface thereof, log(R50a)−log(R50)=0.2 to 1.5. Because the electric resistance value of the developing roller at the time when the low voltage of 50V can be stably applied thereto is set as an index value, it is possible to accurately capture a slight rise of the electric resistance thereof which results from the formation of the oxide film. The lower limit of the solution of the above-described equation is more favorably 0.3 and most favorably 0.5. The upper limit of the solution of the above-described equation is more favorably 1.2 and most favorably 1.0.

The electric resistance values of the produced and recycled developing rollers are favorably 10⁵ to 10⁸Ω and more favorably 10⁵ to 10⁷Ω when the voltage of 500V is applied thereto.

To suppress the generation of a defective image by controlling flowing electric current and prevent discharge to the photosensitive member, the electric resistance value of the developing roller is set to not less than 10⁵Ω. The electric resistance value of the developing roller is set to favorably not more than 10⁸Ω to maintain the toner supply efficiency and prevent the generation of a defective image because the developing roller has a voltage drop when the toner moves to the photosensitive member and thereafter the toner cannot be transported from the developing roller to the photosensitive member securely. The electric resistance value of the developing roller is set to more favorably not more than 10⁷Ω because in the range, the developing roller can be used in wider environment.

In recycling the spent developing roller, it is preferable to set the dielectric loss tangent of the recycled developing roller within the range of 0.1 to 1.8, when an alternating voltage of 5V is applied thereto at a frequency of 100 Hz.

The dielectric loss tangent in the electrical characteristic of the rubber roller means an index indicating the flowability of electricity (conductivity) and the degree of influence of a capacitor component (electrostatic capacity). In other words, the dielectric loss tangent is a parameter indicating a phase delay when an alternating current is applied to the rubber roller, namely, a rate of the capacitor component when a voltage is applied thereto.

That is, the dielectric loss tangent is indicated by a charged amount generated when the toner is brought into contact with the developing roller at a high voltage by means of an amount regulation blade and a charged amount which escapes to the developing roller before the toner is transported to the photosensitive member. Thus the dielectric loss tangent is an index showing the charged amount of the toner immediately before the toner contacts the photosensitive member.

When the dielectric loss tangent is large, it is easy to flow electricity (electric charge) through the developing roller, which makes it difficult for polarization to proceed. On the other hand, when the dielectric loss tangent is small, it is not easy to flow electricity (electric charge) therethrough, which accelerates the polarization. Thus when the dielectric loss tangent is small, the developing roller has a high capacitor-like property. Thereby an electric charge of the toner generated by a frictional charge does not escape from the developing roller, but can be maintained. That is, the developing roller is capable of imparting the electrostatic property to the toner and maintaining the electrostatic property imparted thereto. To obtain the above-described effect, the dielectric loss tangent of the developing roller is set to not more than 1.8. To prevent the print density from becoming too low owing to an excessive increase of the charged amount of the toner and prevent the developing roller from becoming hard owing to the addition of a large amount of additives added to adjust the dielectric loss tangent thereof, the dielectric loss tangent thereof is set to not less than 0.1. The dielectric loss tangent thereof is more favorably not less than 0.3 and most favorably not less than 0.5. The upper limit of the dielectric loss tangent thereof is favorably not more than 1.8, more favorably not more than 1.5, especially favorably not more than 1.0, and most favorably not more than 0.8.

The dielectric loss tangent is measured by a method which will be described later in the examples of the present invention.

The recycled developing roller has a charged amount favorably not less than 25 μC/g and more favorably not less than 28.5 μC/g at a shipping time when the charged amount thereof is measured in a manner described later.

The upper limit of the charged amount of the developing roller is not specifically limited. When the charged amount is too large, it occurs that the charged amount does not satisfy a set value of a printer or a print concentration is low.

In both the original (new) and recycled developing roller, the thickness of the elastomer (when the developing roller consists of one layer made of elastomer) disposed on the outer surface thereof is set to favorably 0.5 to 10 mm and more favorably 1 to 7 mm. The thickness of the elastomer is set to favorably not less than 0.5 mm to obtain a proper nip and the effect of rubber elasticity and favorably not more than 10 mm to make the developing roller compact and lightweight.

The image-forming member to be reproduced by the recycling method of the present invention may contain the following additives unless the use thereof departs from the object of the present invention: a vulcanizing agent, a processing aid, a plasticizer, a acid-accepting agent, a deterioration retarder such as an age resistor; and an ionic-conductive agent.

As the vulcanizing agent, it is possible to use sulfur-based and thiourea-based vulcanizing agents, triazine derivatives, peroxides, and monomers. These vulcanizing agents can be used singly or in combination of two or more of them. As the sulfur-based vulcanizing agent, it is possible to use powdery sulfur, organic sulfur-containing compounds such as tetramethylthiuram disulfide, N,N-dithiobismorpholine, and the like. As the thiourea-based vulcanizing agent, it is possible to use one kind or a plurality of kinds selected from among the group of tetramethylthiourea, trimethylthiourea, ethylenethiourea, and thioureas shown by (CₙH₂₊₁NH)₂C═S (n=integers 1 to 10). As the peroxides, benzoyl peroxide is exemplified. The mixing amount of the vulcanizing agent is set to favorably not less than 0.2 parts by mass nor more than 5 parts by mass and more favorably not less than 1 nor more than 3 parts by mass for 100 parts by mass of the rubber component.

It is preferable to recycle the image-forming member in which a thiourea-based vulcanizing agent is used and especially image-forming member in which ethylene thiourea is used as the vulcanizing agent. The compression set of the image-forming member is adjusted to not more than 10% and favorably not more than 5% by vulcanizing the elastomer component with the thiourea-based vulcanizing agent and especially with ethylene thiourea. Thereby the image-forming member has a small amount of settling at the time of use and transport thereof and is capable of withstanding storage and use at high temperatures. Thus such an image-forming member can be easily reproduced and allows the oxide film to be easily formed by irradiating the surface of the image-forming member with the ultraviolet rays when the image-forming member is produced (new article) and can be recycled easily. In this case, favorably not less than 0.2 nor more than 3 parts by mass and more favorably not less than 1 nor more than 2 parts by mass of the thiourea-based vulcanizing agent and a triazine-based vulcanizing agent are added to 100 parts by mass of the elastomer (rubber) component.

As the plasticizer, it is possible to use dibutyl phthalate (DBP), dioctyl phthalate (DOP), tricresyl phosphate, and wax. As the processing aid, fatty acids such as stearic acid can be used.

It is preferable that the mixing amounts of these plasticizing components are not more than 5 parts by mass for 100 parts by mass of the entire elastomer component to prevent bleeding from occurring in forming the oxide film on the outer surface of image-forming member and prevent the photosensitive member from being contaminated, when the developing roller is mounted on a printer and when the printer is operated. In this respect, it is most favorable to use polar wax as the plasticizing component.

As the deterioration retarder, various age resistors can be used. When NBR rubber or the like is added to the elastomer component to adjust the hardness thereof and improve processability, it is preferable to add the antioxidant as the age resistor according to an addition amount of the NBR rubber or the like. When the antioxidant is used as the deterioration retarder, it is preferable to appropriately select the addition amount thereof to efficiently form the oxide film on the outer surface of the image-forming member.

The surface treatment such as the irradiation of the ultraviolet rays is effective for preventing oozing of additives added to the elastomer component.

When the elastomer contains halogen-containing rubber such as chloroprene rubber, it is preferable that the elastomer contains an acid-accepting agent to prevent remaining of a chlorine-containing gas such as HCl which is generated when the rubber is vulcanized and the photosensitive member from being contaminated. As the acid-accepting agent, it is possible to use various substances acting as acid acceptors. As the acid-accepting agent, hydrotalcites can be favorably used because they have preferable dispersibility. It is preferable to mix not less than 1 nor more than 10 parts by mass of the hydrotalcites for 100 parts by mass of the elastomer component.

The image-forming member to be recycled by the recycling method of the present invention is not limited to the component parts constructing the cartridge, but is used to recycle image-forming members mounted on an image-forming apparatus for use in electrophotographic apparatuses of office automation appliances such as a laser beam printer, an ink jet printer, a copying apparatus, a facsimile, and an ATM. But of the above-described image-forming members, the recycling method of the present invention is applicable to recycle image-forming members containing the elastomer disposed on the outer surfaces thereof exposed to the outside.

As described above, the recycling method of the present invention is most favorably used to recycle the spent developing roller.

A developing method adopted in an image-forming mechanism of the electrophotographic apparatus is classified into a contact type and a noncontact type in terms of the relationship between the photosensitive member and the developing roller. The recycling method of the present invention can be utilized for the developing roller of both types.

As described above, in addition to the developing roller, the recycling method of the present invention can be used to recycle an elastomer members for the image-forming apparatus such as a developing blade, a charging roller for uniformly charging the photosensitive drum, a transfer roller for transferring a toner image from the photosensitive member to a transfer belt or paper, a driving roller for driving the transfer belt from the inside thereof, a fixing roller for toner-fixing use, a cleaning roller, and a cleaning blade.

These rollers may or may not be incorporated in cartridges which are consumable goods.

As described above, in the recycling method of the present invention, the surface, of the image-forming member, consisting of the elastomer is irradiated with the ultraviolet rays or/and the ozone to decompose or/and deteriorate dirt which has attached to the surface of the image-forming member so that the dirt can be removed. Thus without carrying out complicated abrading steps, the spent elastomer member can be recycled. The spent image-forming member can be recycled without changing a dimensional accuracy of the original image-forming member (new article). Therefore the recycling method of the present invention is capable of maintaining the initial dimensional accuracy and does not change the state of contact between the image-forming member and other members of the image-forming apparatus.

In the recycling method of the present invention, a recycling work can be performed easily and inexpensively. Thus the recycling method of the present invention is capable of accelerating the reutilization of the spent image-forming member.

In the recycling method of the present invention, the irradiation of the surface with the ultraviolet rays or/and the ozone prevents a change of the state of the surface of the original image-forming member on which the oxide film is formed. Thus the recycled image-forming member has properties similar to those of the original image-forming member. In addition the spent image-forming member can be recycled repeatedly.

### BRIEF DESCRIPTION OF THE DRAWINGS

FIG. 1 is a perspective view showing a developing roller recycled by the recycling method of the present invention.

FIG. 2 shows the recycling method of the first embodiment.

FIG. 3 shows a method of measuring an electric resistance value of a rubber roller.

FIG. 4 shows a method of measuring a dielectric loss tangent of the rubber roller.

### DETAILED DESCRIPTION OF THE PREFERRED EMBODIMENTS

The embodiments of the method of the present invention for recycling the spent elastomer member for an image-forming apparatus are described below with reference to the drawings.

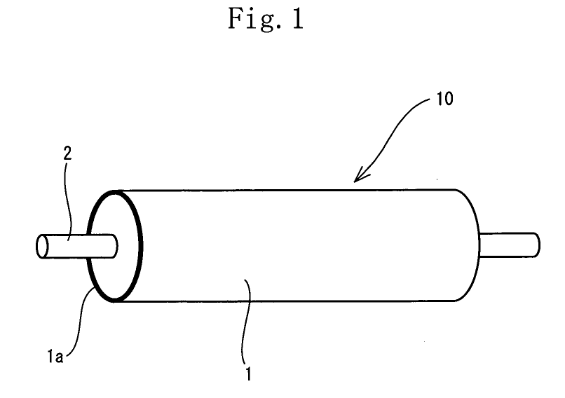

FIG. 1 shows a developing roller 10 recycled by the recycling method of the present invention.

The developing roller 10 is recycled by irradiating the surface of a developing roller used after an elapse of a predetermined endurance period of time. The developing roller 10 has approximately the same configuration and property as those of the developing roller at the time when it was produced.

That is, the developing roller 10 was recycled by extracting it from the toner cartridge after a spent toner cartridge (not shown) was collected from the toner cartridge used by mounting it on an image-forming apparatus.

The developing roller 10 has a cylindrical single-layer roller part 1 consisting of elastomer having a thickness of 10 mm and a columnar core (shaft) 2 inserted into a hollow portion of the roller part 1 by press fit. The core 2 is made of metal such as aluminum, an aluminum alloy, SUS or iron or ceramics.

The roller part 1 is made of a conductive elastomer to form the roller part 1 as a conductive roller. The roller part 1 and the core 2 are bonded to each other with a conductive adhesive agent.

The outer surface layer of the roller part 1 consisting of the elastomer exposed to the outside is irradiated with ultraviolet rays to form an oxide film 1a thereon.

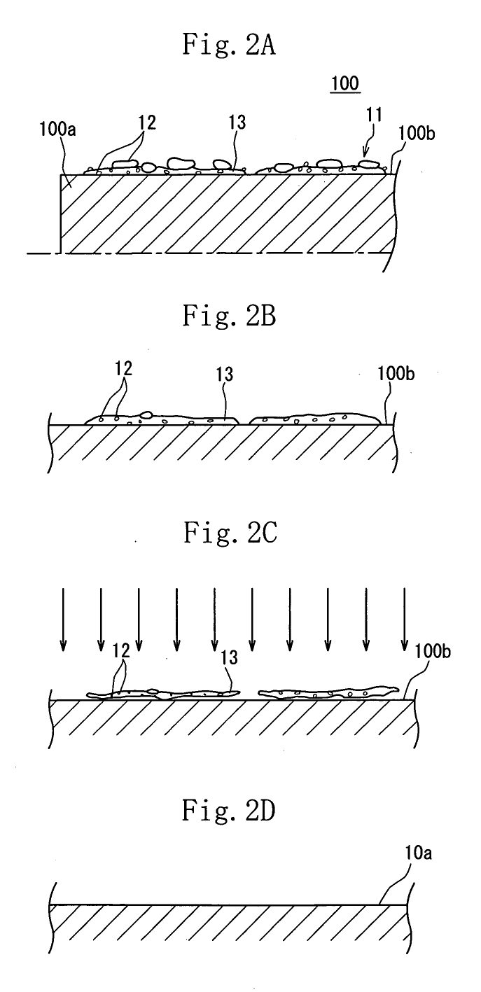

FIG. 2A shows a developing roller 100 before it is recycled. An oxide film 100b is formed by irradiating the surface of a roller part 100a composed of a conductive elastomer with ultraviolet rays when the developing roller 100 is produced. A deposit 11 (hereinafter referred to as dirt) has attached to and accumulated on the surface of the oxide film 100b during the use of the developing roller 100.

The dirt 11 mainly contains a solid matter 12 in various sizes such as resin-forming toner, an additive externally added to the toner to enhance the flowability thereof, a colorant contained in the toner, and powder of paper on which print is performed and a pasty component 13 such as wax, a low-molecular-weight polymer, and the like contained inside the toner.

The method of recycling the spent developing roller 100 to obtain the recycled developing roller 10 shown in FIG. 1 is described below.

Initially air blow, suction or water-washing is performed to remove large solid matters having a size not less than about 1 μm and solid matters which can be easily dropped from the surface of the spent developing roller 100, as shown in FIG. 2B.

These works should be performed in dependence on the extent of dirt and does not necessarily have to be done. In the case where a lot of dirt has attached to the surface of the spent developing roller 100, it is preferable to beforehand remove the large solid matters and dirt which can be easily dropped.

In the case where the surface of the spent developing roller 100 is washed with water, the surface thereof is dried.

Thereafter as shown with arrows of FIG. 2C, the surface of the spent developing roller 100 is irradiated with ultraviolet rays (184.9 nm and 253.7 nm) by an ultraviolet ray irradiator. More specifically, the surface thereof is irradiated with ultraviolet rays at intervals of 90 degrees in its circumferential direction for a predetermined period of time, favorably 1 to 15 minutes and more favorably 5 to 10 minutes. The spent developing roller 100 is rotated by at four times in its circumferential direction to irradiate its entire peripheral surface (360 degrees).

Of the dirt 11, the pasty component 13 serving as the medium on which the solid matter 12 or the like accumulate is oxidatively decomposed or deteriorated by irradiating the surface of the spent developing roller 100 with the ultraviolet rays. The very thin pasty component 13 which has been decomposed or deteriorated is solidified and easily separates from the surface of the spent developing roller 100.

Thereafter air blow is performed to completely remove the solidified dirt 11. Thereby as shown in FIG. 2D, the dirt is removed from the surface of the spent developing roller 100 to obtain the recycled developing roller 10.

After the surface of the spent developing roller 100 is irradiated with the ultraviolet rays, the solidified dirt 11 drop of itself and is removed by slight vibration. Thus the air blow does not necessarily have to be carried out after the surface of the spent developing roller 100 is irradiated with the ultraviolet rays. But to accomplish the work efficiently, it is effective to perform the air blow.

The dirt is removed from the surface of the recycled developing roller 10, shown in FIG. 1, which is obtained by carrying out the above-described method. Because an abrading step is not performed, the dimensional accuracy of the recycled developing roller 10 is as high as that of the developing roller (new article) when it is produced.

That is, when an alternating voltage of 5V is applied to the recycled developing roller 10 at a frequency of 100 Hz, the dielectric loss tangent thereof is in the range from 0.1 to 1.8, the electric resistance value thereof is in the range from 10⁵ to 10⁸Ω when a voltage of 500V is applied thereto, and the charged amount of toner is not less than 30 μC/g. The recycled developing roller 10 has performance similar to that of the developing roller (new article) when it is produced.

The dielectric loss tangent, the electric resistance value of the recycled developing roller 10, and the charged amount of toner are measured by the method described in the example of the present invention which will be described later.

The developing roller reproduced by the recycling method is composed of components described below and produced by a method described below.

The single-layer conductive elastomer constituting the roller part contains 10 to 90 parts by mass of chloroprene and 10 to 90 parts by mass of ionic-conductive epichlorohydrin rubber in 100 parts by mass of the entire elastomer component.

To adjust the dielectric loss tangent within the predetermined range, 20 to 70 parts by mass of weakly conductive carbon black is added to 100 parts by mass of the entire elastomer component.

0.2 to 3 parts by mass of sulfur and 0.2 to 5 parts by mass of a thiourea-based vulcanizing agent (ethylene thiourea) are added 100 parts by mass of the entire elastomer component as vulcanizing agents. 1 to 10 parts by mass of hydrotalcite is added to 100 parts by mass of the entire elastomer component as an acid-accepting agent to prevent the developing roller from polluting a photosensitive member.

As described above, an oxide film 1a is formed on the surface of the rubber roller produced from the above-described components by carrying out a known method. The oxide film 1a is formed by abrading the surface of the produced rubber roller by a cylindrical grinder to mirror-like surface finish so that the surface roughness of the rubber roller is not more than 6.5 μm and preferably 3 to 5 μm, washing the surface thereof with water, and irradiating the surface thereof with the ultraviolet rays (184.9 nm and 253.7 nm) by an ultraviolet ray irradiator.

More specifically, the surface of the rubber roller is irradiated with ultraviolet rays at intervals of 90 degrees in its circumferential direction for a predetermined period of time, favorably 1 to 15 minutes and more favorably 5 to 10 minutes. The rubber roller is rotated at four times in circumferential direction thereof to form an oxide film on the entire peripheral surface thereof.

The recycling method of the present invention may be carried out by irradiating the surface of the spent developing roller with ozone instead of the ultraviolet rays.

In recycling the spent developing roller by irradiating the surface thereof with the ozone, the surface thereof is irradiated with the ozone in an atmosphere of an ozone concentration of 0.01 to 100 ppm and favorably 0.1 to 50 ppm for 0.5 minutes to 50 hours and favorably one minute to 24 hours under the condition where the temperature is 23° C. and a relative humidity is 55%.

Because other producing steps and effects obtained by the recycling method to be carried out by irradiating the surface of the spent developing roller with the ozone are similar to the above-described embodiment, the description thereof is omitted herein.

The examples of the present invention are described below.

Formation of Rubber Roller (New Article)

After components shown in table 1 were kneaded by a Banbury mixer, the kneaded components were extruded by an extruder to obtain a tube having an outer diameter of 022 mm and an inner diameter of φ 9.5 mm.

The tube was mounted on a shaft for vulcanizing use. After the rubber component was vulcanized by a vulcanizing can at 160° C. for one hour, the tube was mounted on a shaft, having a diameter of φ10 mm, to which an electroconductive adhesive agent was applied. The tube and the shaft were bonded to each other in an oven having a temperature of 160° C. After both ends of each of the obtained rubber roller were molded, traverse polishing was performed on the surface thereof by using a cylindrical polishing machine. Thereafter the surface of the rubber roller was polished to a mirror-like surface finish. As a result, the rubber roller having φ20 mm (tolerance: 0.05) was obtained.

The obtained rubber roller had a surface roughness Rz of 3 to 5 μm.

The surface roughness Rz was measured in accordance with JIS B 0601 (1994).

TABLE 1

| | | Mixing amount |
|---|---|---|
| Component | | (part by mass) |
| Elastomer component | Chloroprene | 50 |
| | Epichlorohydrin | 50 |
| Vulcanizing agent | Powdery sulfur | 0.5 |
| | Ethylene thiourea | 1.4 |
| Acid-accepting agent | Hydrotalcite | 3 |
| Agent for adjusting | Weakly conductive | 40 |
| dielectric loss tangent | carbon black | |

The following products were used as the components described in table 1:
chloroprene rubber: “Shoprene WRT (commercial name)” produced by Showa Denko K.K.

Epichlorohydrin rubber (ECO): “Epichlomer D (commercial name)” produced by DAISO CO., LTD.

[EO(ethylene oxide):EP(epichlorohydrin)=61 mol %:39 mol %]

Powdery sulfur: produced by Tsurumi Chemical Industry Co., Ltd.

Ethylene thiourea “Accel 22-S (commercial name)” produced by KAWAGUCHI CHEMICAL INDUSTRY CO., LTD.

Hydrotalcite: “DHT-4A-2” (commercial name)” produced by Kyowa Chemical Industry Co., Ltd.

Weakly conductive carbon black: “Asahi #15 (commercial name)” (average primary particle diameter:122 nm) produced by Asahi Carbon Co., Ltd.

After the surface of each roller was washed with water, the surface thereof was irradiated with ultraviolet rays to form an oxide film thereon.

In the method of irradiating the surface of the rubber roller with the ultraviolet rays, by using an ultraviolet ray irradiation lamp (“PL21-200” produced by Special source Sen Co., Ltd.), the surface of rubber roller was irradiated with ultraviolet rays (wavelength: 184.9 nm and 253.7 nm) at intervals of 90 degrees in its circumferential direction for five minutes with the ultraviolet ray irradiation lamp spaced at 5 cm from the rubber roller. The rubber roller was rotated by 90 degrees four times to form an oxide film on its entire peripheral surface (360 degrees). The surface of the rubber roller was irradiated with ultraviolet rays for five minutes per 90 degrees. Thus the whole irradiation period of time was 20 minutes.

Formation of Roller to which Dirt has Attached

The produced rubber roller was mounted as a developing roller on a commercially available toner cartridge in which an unmagnetic one-component toner to be charged positively is used.

Thereafter the toner cartridge was mounted on a commercially available printer to perform print on sheets of paper at 5% under the condition of a normal temperature and a normal humidity (23° C., 55%) till toner is exhausted Thereafter the same amount of toner as that used for a new article was filled in a toner cartridge to perform print on sheets of paper at 5% till the toner is exhausted. As a result, a deposit was visible on the surface of the developing roller.

Description of Recycling Method

The following recycling method was performed for a prepared roller having dirt attached thereto.

### EXAMPLE 1

After the surface of the roller having dirt attached thereto was cleaned with water and air-dried, the roller was irradiated with ultraviolet rays (wavelength: 184.9 nm and 253.7 nm) at intervals of 90 degrees in its circumferential direction for five minutes with the ultraviolet ray irradiation lamp spaced at 5 cm from the roller. The roller was rotated by 90 degrees four times to irradiate the entire peripheral surface (360 degrees) thereof at one time. The surface of the developing roller was irradiated with ultraviolet rays for five minutes per 90 degrees. Thus the whole irradiation period of time was 20 minutes.

### EXAMPLE 2

After air was blown to the surface of the developing roller having dirt attached thereto, the surface thereof was irradiated with the ultraviolet rays at a first time irradiation. Thereafter the surface of the roller was cleaned with water. After the surface of the roller was air-dried, the surface thereof was irradiated with the ultraviolet rays at a second time irradiation.

The condition of the first-time irradiation and second-time irradiation of the ultraviolet rays and the condition of washing the surface of the roller with water were similar to those of the example 1.

### EXAMPLE 3

After air was blown to the surface of the roller having dirt attached thereto, the surface thereof was irradiated with the ultraviolet rays. After the surface of the roller was cleaned with water, it was air-dried.

The condition of the irradiation of the ultraviolet rays and the condition of washing the surface of the roller with water were similar to those of the example 1.

### REFERENCE EXAMPLE

A new rubber roller having no dirt attached thereto was used.

### COMPARISON EXAMPLE 1

A rubber roller having dirt attached thereto was used without recycling it.

### COMPARISON EXAMPLE 2

Traverse abrasion was performed on the surface of a rubber roller having dirt attached thereto by a cylindrical abrader. Thereafter the surface thereof was lapped to mirror-like surface finish in a depth of 50 μm to recycle the rubber roller.

The electric resistance and dielectric loss tangent of the rubber roller and the charged amount of toner on each rubber roller of the examples 1 through 3, the reference example, and the comparison examples 1,2, were measured, and the qualities of images were evaluated. Table 2 shows the results.

TABLE 2

| | | | Electric | | Charged | |
|---|---|---|---|---|---|---|
| | | | resistance | Dielectric | amount | Image |
| | Specimen | Recycling method | (logΩ) | loss tangent | (μC/g) | quality |
| Reference | New article | — | 6.2 | 0.7 | 39.5 | ⊚ |
| example | | | | | | |
| Example 1 | Roller to which | Water-washing → Irradiation | 6.2 | 0.8 | 38 | ◯ |
| | dirt has attached | of ultraviolet rays | | | | |
| Example 2 | Roller to which | Air blow → Irradiation of | 6.2 | 0.7 | 39.7 | ⊚ |
| | dirt has attached | ultraviolet rays → Water-washing | | | | |
| | | → Irradiation of ultraviolet rays | | | | |
| Example 3 | Roller to which | Air blow → Irradiation of | 6.2 | 0.7 | 38.5 | ◯ |
| | dirt has attached | ultraviolet rays → Water-washing | | | | |
| Comparison | Roller to which | Not recycled | 6.4 | 0.8 | 45 | X |
| Example 1 | dirt has attached | | | | | |
| Comparison | Roller to which | Surface layer was abraded in | 6.1 | 1.5 | 20 | X |
| Example 2 | dirt has attached | depth of 50 μm | | | | |

The electric resistance, the dielectric loss tangent, and the charged amount of toner were measured by methods described below.

Measurement of Electric Resistance of Rubber Roller

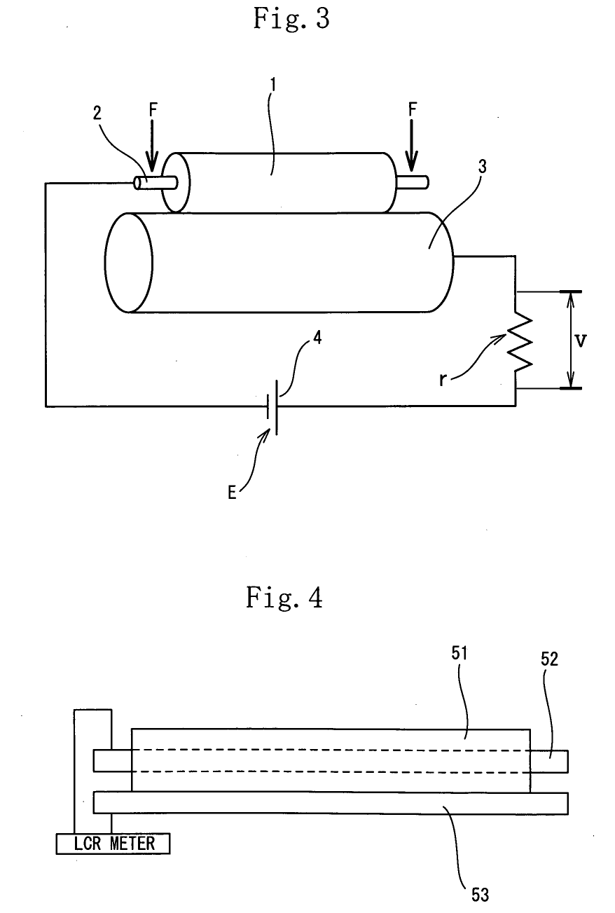

To measure the electric resistance of each rubber roller, as shown in FIG. 3, a rubber layer 1 through which a core 2 was inserted was mounted on an aluminum drum 3, with the rubber layer 1 in contact with the aluminum drum 3. A leading end of a conductor, having an internal electric resistance of r (100Ω), which was connected to a positive side of a power source 4 was connected to another end surface of the aluminum drum 3. A leading end of a conductor connected to a negative side of the power source 4 was connected to one end surface of a conductive rubber roller.

A voltage V applied to the internal electric resistance r of the conductor was detected.

Supposing that a voltage applied to the apparatus is E, the electric resistance R of the rubber roller is: R=r×E/(V−r). Because the term −r is regarded as being extremely small, R=r×E/V.

A load F of 500 g was applied to both ends of the core 2. The voltage E of 500V was applied to the apparatus, while the rubber roller was being rotated at 30 rpm. 100 detected voltages V were measured during four seconds. The electric resistance value R was computed by using the above equation.

The electric resistance value R was measured at a constant temperature 23° C. and a constant relative humidity of 55%.

Measurement of Dielectric Loss Tangent

As shown in FIG. 4, an alternating voltage of 5V and a frequency of 100 Hz is applied to a rubber roller 51 placed on a metal plate 53. A shaft 52 and the metal plate 53 served as an electrode respectively. A component R (electric resistance) and a component C (capacitor) are measured separately by an LCR meter (AG-4311B, manufactured by Ando Electric Co., Ltd.). The dielectric loss tangent was computed from the measured R and C by using the following equation. The component R and the component C were measured at 23° C. to 24° C. (room temperature).

Dielectric loss tangent (tan δ)=G/(ωC), G=1/R

The dielectric loss tangent is found as G/ωC, when the electrical characteristic of one roller is modeled as two kinds of parallel equivalent circuits of the electric resistance component of the roller and the capacitor component thereof.

Measurement of Charged Amount of Toner Indicating Printing Characteristic and Evaluation of Image Quality

The rubber roller of each of the examples, the comparison examples, and the reference example was mounted on a commercially available laser printer. An image was printed at 5% on 100 sheets of paper to allow toner to have a steady state. When print of a halftone image at 25% finished, the charged amount of the toner was measured to use it as the evaluation parameter. More specifically, after the halftone image was printed at 25%, a cartridge was removed from the laser printer. The toner was sucked by a suction-type charged amount measuring machine (“Q/m METER Model 210HS-2” produced by Treck Inc.) disposed above the developing roller mounted on the cartridge to measure the charged amount (μC) and the weight (g) of the sucked toner by a weight meter. The amount of static electricity per weight(mass) was computed as the charged amount (μC/g).

The image quality was visually evaluated as described below.

⊚: Excellent (Nonuniformity was not generated in the circumferential and longitudinal directions of the rubber roller nor color omission was generated. The image obtained was as sharp as that provided when a new article was mounted on the above-described laser printer).
◯: Good (Nonuniformity was not generated in the circumferential and longitudinal directions of the rubber roller nor color omission was generated. The sharpness degree of the image obtained was almost the same as that provided when a new article was mounted on the laser printer).
Δ: A little better than “Poor” (Nonuniformity was slightly generated in the circumferential and longitudinal directions of the rubber roller. Color omission was also slightly generated).
X: Poor (Nonuniformity was generated in the circumferential and longitudinal directions of the rubber roller. Color omission occurred).

In the rubber roller of the comparison example 1 not recycled, owing to a partial dirt, nonuniformity was generated in the circumferential direction thereof in the image quality. That is, the rubber roller caused the image quality to be low. The charged amount of toner was as large as 45 μC/g. As a whole, the print concentration was weak.

The rubber roller of the comparison example 2 recycled by abrading the surface thereof had a favorable electric resistance value which had a small difference from that of the rubber roller (new article) of the reference example but had a dielectric loss tangent as large as 1.5. The charged amount of toner was about half of that of toner charged by the rubber roller of the reference example. The image quality was also low. That is, the performance of the recycled rubber roller was inferior to the original rubber roller.

On the other hand, the electric resistances, dielectric loss tangents, charged amounts, and image qualities of the rubber rollers of the examples 1 through 3 recycled by the recycling method of the present invention were almost equal to those of a new rubber roller. That is, the rubber rollers of the examples 1 through 3 showed excellent performance.

In the embodiments and the examples, the method of recycling the developing roller has been described. But the recycling method of the present invention is also applicable to other image-forming members such as a transfer roller, a charging roller, a cleaning blade, and the like.

What is claimed is:

1. A method for recycling a spent image-forming member mounted inside an image-forming apparatus to reuse said image-forming member,
wherein said image-forming member is made of an elastomer before said image-forming member is recycled;
when a recycling work is performed, a surface of said image-forming member is not abraded, but irradiated with ultraviolet rays or ozone at least once to decompose or/and deteriorate a deposit which has attached to said surface thereof in a use thereof so that said deposit is removed from said surface thereof.

2. The recycling method according to claim 1, wherein air blow or/and water-washing are performed at a step before or after said surface of said image-forming member is irradiated with said ultraviolet rays or said ozone; and
said surface of said image-forming member is irradiated at least once with said ultraviolet rays having a wavelength of 100 to 400 nm for 30 seconds to 30 minutes;
said surface of said image-forming member is irradiated at least once with said ozone at 0.01 to 100 ppm for 0.5 minutes to 50 hours.

3. The recycling method according to claim 1, wherein said elastomer disposed on said surface of said image-forming member contains chlorine atoms.

4. The recycling method according to claim 1, wherein said elastomer disposed on said surface of said image-forming member consists of vulcanized rubber; and an oxide film is formed on said surface of said image-forming member by irradiating said surface thereof with said ultraviolet rays or/and said ozone when said image-forming member is produced.

5. The recycling method according to claim 2, wherein said elastomer disposed on said surface of said image-forming member consists of vulcanized rubber; and an oxide film is formed on said surface of said image-forming member by irradiating said surface thereof with said ultraviolet rays or/and said ozone when said image-forming member is produced.

6. The recycling method according to claim 3, wherein said elastomer disposed on said surface of said image-forming member consists of vulcanized rubber; and an oxide film is formed on said surface of said image-forming member by irradiating said surface thereof with said ultraviolet rays or/and said ozone when said image-forming member is produced.

7. The recycling method according to claim 1, wherein said deposits including at least one of toner, wax which is a component of said toner, paper powder, a liquid additive, and a low-molecular-weight polymer attach to said surface of said image-forming member to be recycled; and said image-forming member is exchangeably mounted on an image-forming apparatus as a cartridge and consists of a developing roller, a toner supply roller, and a developing blade constructing a toner cartridge, a charging roller, a cleaning roller, a transfer roller, and a cleaning blade constructing a photosensitive drum cartridge or/and a fixing roller constructing a fixing cartridge.

8. The recycling method according to claim 2, wherein said deposits including at least one of toner, wax which is a component of said toner, paper powder, a liquid additive, and a low-molecular-weight polymer attach to said surface of said image-forming member to be recycled; and said image-forming member is exchangeably mounted on an image-forming apparatus as a cartridge and consists of a developing roller, a toner supply roller, and a developing blade constructing a toner cartridge, a charging roller, a cleaning roller, a transfer roller, and a cleaning blade constructing a photosensitive drum cartridge or/and a fixing roller constructing a fixing cartridge.

9. The recycling method according to claim 3, wherein said deposits including at least one of toner, wax which is a component of said toner, paper powder, a liquid additive, and a low-molecular-weight polymer attach to said surface of said image-forming member to be recycled; and said image-forming member is exchangeably mounted on an image-forming apparatus as a cartridge and consists of a developing roller, a toner supply roller, and a developing blade constructing a toner cartridge, a charging roller, a cleaning roller, a transfer roller, and a cleaning blade constructing a photosensitive drum cartridge or/and a fixing roller constructing a fixing cartridge.

10. An image-forming member which is recycled by the method according to claim 1 and has an oxide film formed on an outermost surface thereof.

11. An image-forming member which is recycled by the method according to claim 2 and has an oxide film formed on an outermost surface thereof.

12. An image-forming member which is recycled by the method according to claim 3 and has an oxide film formed on an outermost surface thereof.
